(19) United States
(12) Patent Application Publication
(10) Pub. No.: US 2013/0309774 A1
(43) Pub. Date: Nov. 21, 2013

(54) ANALYTE QUANTITATION WITH ISOBARIC TAGGING

(71) Applicants: Vladimir ZABROUSKOV, Belmont, CA (US); John C. ROGERS, Rockton, IL (US)

(72) Inventors: Vladimir ZABROUSKOV, Belmont, CA (US); John C. ROGERS, Rockton, IL (US)

(21) Appl. No.: 13/475,593

(22) Filed: May 18, 2012

(51) Int. Cl. G01N 27/62

(52) U.S. Cl. 436/86; 436/173

(57) ABSTRACT

A set of two or more types of isobaric tags is described where each tag in the set includes a mass-labeling group and a mass-normalizing group. The mass-labeling group includes a reactive group configured to form a first bond to a functional group of an analyte. The mass-normalizing group is attached to the mass-labeling group via a second bond. The first bond is configured to be stable when subjected to a dissociative energy level from a mass spectrometer so that the first bond does not cleave. When subjected to the same dissociative energy level, the second bond is configured to cleave that liberates the mass-normalizing groups. The tag is configured to form a charged mass-labeled analyte when the second bond is cleaved.

### BACKGROUND

Mass spectrometry has been increasingly used to perform quantification of proteins and peptides, due in part to its ability to concurrently analyze numerous proteins in a sample with high resolution and low detection limits. In many proteomics studies, there is a need to analyze a large number of samples, each containing many individual proteins or peptides. Such large-scale studies have motivated researchers to develop strategies to increase the number of samples that can be analyzed in a given time period. One strategy for increasing sample throughput is multiplexing, where several samples are combined and tested together in a mass spectrometer. With multiplexing, a unique chemical label can be used with each sample of peptides so that a particular peak in a mass spectrum can be correlated to a particular sample.

An isobaric tag is a type of chemical label that can be used in a multiplexed analysis of peptides. Some examples of commercially available isobaric tags are TMT (Tandem Mass Tag Reagents, Thermo Scientific, Pierce Protein Research Product) and iTRAQ (Isobaric Tagging Relative Absolute Quantitation, Applied Biosystem). A set of isobaric tags can have two or more types, where each type has a reporter group with a unique mass within the set. Although the reporter groups have a different mass, the isobaric tags include mass-normalizing groups, such that the total mass for each type of tag in the set is the same. The isobaric tag can covalently attach to the analyte to form a tag labeled analyte. Next, the tag labeled analytes can be fragmented using tandem mass spectrometry (e.g., MS²) to cause a reporter group ion to be liberated. The abundances of the reporter group ions are determined from the acquired product ion spectra. The relative abundance of each type of reporter group ion corresponds to the abundance of a particular protein in the sample.

For example, in a multiplexing study with four different samples, they can each be labeled with an isobaric tag having a unique reporter group. All of the tag labeled analytes can be co-isolated in a mass spectrometer because they have the same m/z value and in the process be separated from other ions having different m/z values. Next, the isolated ions can be fragmented causing the reporter ions to be cleaved. The cleaved reporter ions can then be analyzed with the mass spectrometer. Here, four mass spectral peaks should be measured that correlate to the four types of reporter groups. The abundance value for the reporter groups can then be correlated to a relative protein concentration for each sample.

Under certain circumstances, the accuracy of peptide quantitation determined by the isobaric tagging technique may be compromised due to the presence of interfering species. In MS² analysis, a mass spectrometer will typically co-isolate ions within a two to three Th (m/z) range. In such a case, the ion isolation step can include both tag labeled analyte and tag labeled non-analyte species that fall within the mass isolation window. As a result, tag labeled non-analyte will contribute to the reporter group signal and thereby render inaccurate the measurement of the abundance of the associated peptide. It should be noted that the reporter group becomes anonymous (i.e., the identity of the precursor ion from which it was formed is lost) once it is cleaved from the peptide. Thus, the cleaved reporter ion intensity signal cannot be later processed to remove the effects of interfering ions co-isolated in the ion trap. While several researchers have developed techniques for reducing the effects of the presence of interfering species on peptide quantitation (Ting et. al., Nature Methods, volume 8,937-940 (2011); Christoforou et. al., Nature Methods, volume 8, 911-913 (2011)), Applicants believe that there remains a need for an improved tagging technique that increases the accuracy in quantitation of peptides with mass spectrometry.

### SUMMARY

A set of two or more types of isobaric tags is described where each tag in the set includes a mass-labeling group and a mass-normalizing group. The mass-labeling group includes a reactive group configured to form a first bond to a functional group of an analyte. The first bond is configured to be stable when subjected to a dissociative energy level from a mass spectrometer so that the first bond does not cleave. The mass-normalizing group is attached to the mass-labeling group via a second bond. The second bond is configured to cleave when subjected to the dissociative energy level from the mass spectrometer. A mass of each type of tag in the set is about the same. A mass of a mass-labeling group for each type of tag in the set is different. The tag is configured to form a charged mass-labeled analyte when the second bond is cleaved. The mass-normalizing group is configured to form a neutral molecule when the second bond is cleaved.

A method of analyzing an analyte with isobaric tags is described. A first type of tag is incubated with a first sample containing a first concentration of the analyte to form a first tag labeled analyte. The first tag labeled analyte includes a first mass-labeling group and a first mass-normalizing group. The first mass-labeling group can be coupled to the analyte via a first bond. The first mass-normalizing group can be coupled to the first mass-labeling group via a second bond. A second type of tag is incubated with a second sample containing a second concentration of the analyte to form a second tag labeled analyte. The second tag labeled analyte includes a second mass-labeling group and a second mass-normalizing group. The second mass-labeling group can be coupled to the analyte via a first bond. The second mass-normalizing group can be coupled to the second mass-labeling group via a second bond. The first tag labeled analyte and the second tag labeled analyte can be subjected to a dissociative energy level with a mass spectrometer. The second bond of the first tag labeled analyte is cleaved to form a neutral first mass-normalizing group and a first charged mass-labeled analyte. The second bond of the second tag labeled analyte is cleaved to form a neutral second mass-normalizing group and a second charged mass-labeled analyte. The first and second mass-normalizing groups are both configured to form a neutral molecule when the second bond is cleaved. A mass-to-charge ratio can be measured for the first charged mass-labeled analyte and the second charged mass-labeled analyte where the mass-to-charge ratio of the first charged mass-labeled analyte is different than the second charged mass-labeled analyte. The first concentration and the second concentration can be determined based on of the abundance values of the respective mass-to-charge ratios of the first charged mass-labeled analyte and the second charged mass-labeled analyte.

A method of analyzing an analyte with isobaric tags is described where one or more mass spectral peaks corresponding to the mass-labeled analyte are missing in the mass spectrum. Under certain circumstances, the analyte concentration for a particular sample is sufficiently small to cause the peak(s) corresponding to the mass-labeled analyte(s) to be absent from the mass spectrum (i.e., not detectable above the noise level). For example, in one or more samples, a genetic mutation of a cell can cause a down regulation process in the protein biosynthetic pathway, resulting in no or significantly reduced expression of the analyte protein. The absence of multiple mass-labeled analyte peaks in the spectrum may render peak assignment difficult and confound its interpretation. In accordance with the present method, a set of tags having characteristic mass intervals are utilized to facilitate peak assignment when one or more of the expected mass-labeled analyte peaks are not observed in the mass spectrum. A first type of tag is incubated with a first sample that contains the analyte to form a first tag labeled analyte. The first tag labeled analyte includes a first mass-labeling group and a first mass-normalizing group. The first mass-labeling group has a primary mass and can be coupled to the analyte. The first mass-normalizing group can be coupled to the first mass-labeling group. A second type of tag is incubated with a second sample that contains the analyte to form a second tag labeled analyte. The second tag labeled analyte includes a second mass-labeling group and a second mass-normalizing group. The second mass-labeling group has a second mass and can be coupled to the analyte. The second mass can be greater than the primary mass by a first predetermined mass interval. The second mass-normalizing group can be coupled to the second mass-labeling group. A third type of tag is incubated with a third sample that contains the analyte to form a third tag labeled analyte. The third tag labeled analyte includes a third mass-labeling group and a third mass-normalizing group. The third mass-labeling group has a third mass and can be coupled to the analyte. The third mass can be greater than the primary mass by a second predetermined mass interval. The third mass-normalizing group can be coupled to the third mass-labeling group. Next, the first, second, and third samples can be combined together to form a sample mixture. The sample mixture can be subjected to a dissociative energy level with a mass spectrometer suitable for cleaving mass-normalizing groups from tag labeled analytes to form charged mass-labeled analytes. Mass-to-charge ratio values of charged mass-labeled analytes can be measured. This method then allows the identification of mass spectral peaks that correspond to a type of charged mass-labeled analytes so long as there are at least two mass-to-charge ratio values. In this method, at least two mass spectral peaks need to have a mass spacing that corresponds to a predetermined intracluster mass interval value or to a sum of two or more predetermined intracluster mass interval values. A first predetermined intracluster mass interval includes a mass difference between the second and the first type of tags. A second predetermined intracluster mass interval includes a mass difference between the third and the second type of tags.

An alternative embodiment of a set of two or more types of isobaric tags is described where each tag in the set includes two sources for measuring analyte, which are from a mass-labeling group and a signal group. The mass-labeling group includes a reactive group configured to form a first bond to a functional group of an analyte. The first bond is configured to be stable when subjected to a dissociative energy level from a mass spectrometer so that the first bond does not cleave. The signal group is attached to the mass-labeling group via a second bond. The second bond is configured to cleave when subjected to the dissociative energy level. A mass of each type of tag in the set is about the same. A mass of a mass-labeling group for each type of tag in the set is different and a mass of a signal group for each type of tag in the set is also different. The tag is configured to form a charged mass-labeled analyte and a separated charged signal group when the second bond is cleaved.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements). A detailed understanding of the features and advantages of the present invention will be obtained by reference to the following detailed description that sets forth illustrative embodiments, in which the principles of the invention are utilized, and the accompanying drawings of which:

FIG. 1 illustrates a schematic of an isobaric tag that includes a mass-normalizing group, a reporter group, and a reactive group;

FIG. 2 illustrates a schematic of the isobaric tag of FIG. 1 where the mass-normalizing group has been cleaved off to form a neutral molecule and leaving a charged mass-labeled analyte;

FIG. 3 illustrates an example of a mass spectrum of a sample mixture using a set of isobaric tags in accordance with a first embodiment;

FIG. 4 shows a simplified and expanded mass spectrum illustrating predetermined mass intervals and intracluster mass intervals of a fragment cluster;

FIG. 5 illustrates a schematic representing permutations of intracluster mass interval spacings of a fragment cluster having one peak missing;

FIG. 6 illustrates a schematic representing permutations of intracluster mass interval spacings of a fragment cluster having two peaks missing;

FIG. 7 illustrates a schematic of an alternative embodiment of an isobaric tag that includes a mass-labeling group, a signal group, and a reactive group; and

FIG. 8 illustrates a schematic of the isobaric tag of FIG. 7 where the signal group has been cleaved off to form a charged molecule and leaving a charged second mass-labeled analyte.

### DETAILED DESCRIPTION OF EMBODIMENTS

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. As used herein, the terms “about” or “approximately” for any numerical values or ranges indicate a suitable dimensional tolerance that allows the part or collection of components to function for its intended purpose as described herein.

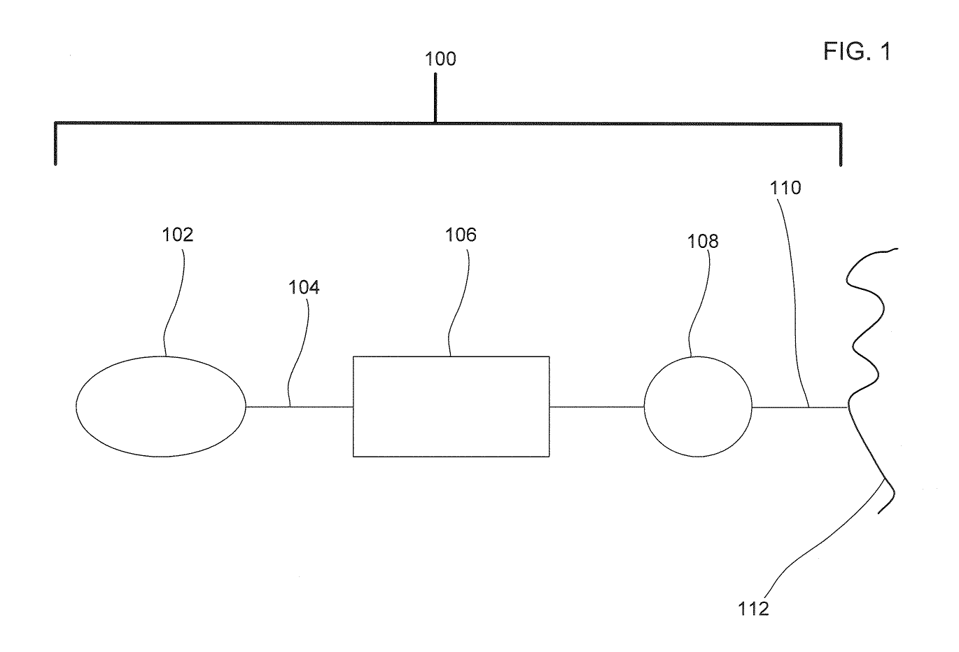

An isobaric tag will be described where the mass-labeling group remains attached to the analyte during analysis with a mass spectrometer. This will allow the quantitation information to be ascribed to a particular analyte such as, for example, a specific sequence of amino acids. Although the analyte has been described as being a protein or peptide, other analyte molecules may be used with the isobaric tags described herein that may include glycans, steroids, nucleotides, sugars, toxins, lipids, and low molecular weight metabolites. FIG. 1 illustrates a schematic of an isobaric tag 100 coupled to an analyte 112. Isobaric tag 100 includes a mass-normalizing group 102 and a mass-labeling group 106. The mass-labeling group 106 includes a reactive group 108 configured to form a first bond 110 to a functional group of an analyte 112 in a sample. Mass-normalizing group 102 is attached to mass-labeling group 106 via a second bond 104. The attachment of mass-normalizing group 102 to mass-labeling group 106 is not limited to a direct attachment and can include an intermediate or intervening group such as, for example, a spacer group.

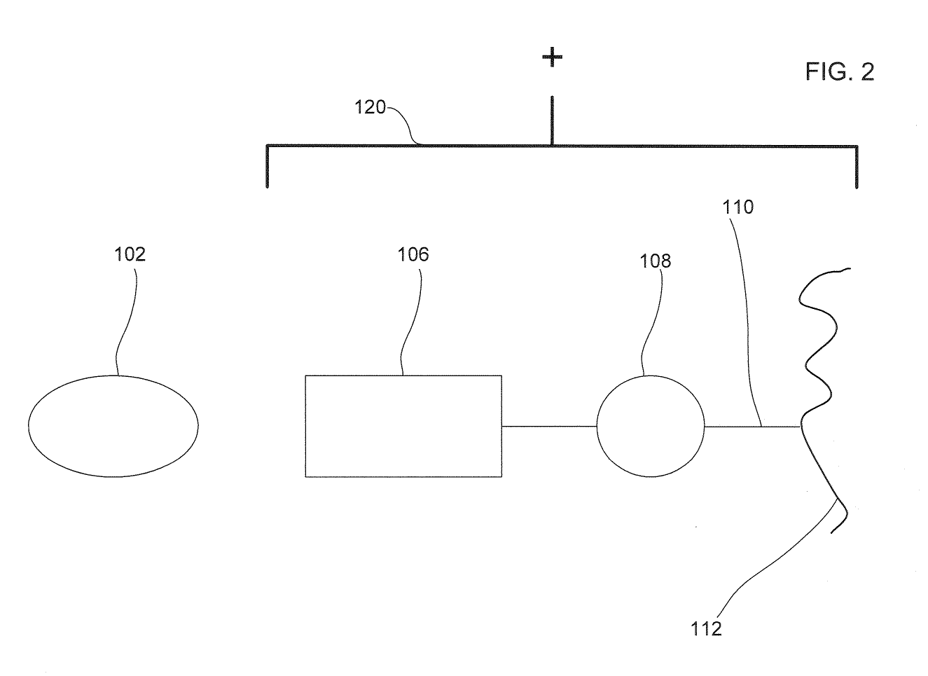

First bond 110 is configured to be stable and not cleave when subjected to a dissociative energy level. When subjected to the same dissociative energy level, second bond 104 is configured to cleave so that mass-normalizing group 102 forms a separated neutral molecule, as illustrated in FIG. 2. In turn, a remainder portion of the tag forms a charged mass-labeled analyte 120, as illustrated in FIG. 2. The relative yield of cleaving second bond 104 of the tag labeled analyte can be about the same for each type of tag in the set. It should be noted that a range of dissociative energy levels to fragment the tag labeled analyte can be selected to optimize the yield of cleaving first bond 110, while at the same time, not cleaving second bond 104, the internal bonds of mass-labeling group 106, and of analyte 112. The dissociative energy levels used in fragmenting the tag labeled analyte may be referred to as standard collisionally activated dissociation (CAD) conditions.

In another embodiment, the analyte portion of the tag labeled analyte can also be partially fragmented so long as there is a measurable amount of the fragmented analyte species. The fragmented analyte species includes a fragmented portion of the analyte that is still attached to the mass-labeling group 106. The analyte portion of the analyte fragment species can fragment in the same way with a similar yield for each type of tag labeled analyte in the set so that relative measurements can be made with respect to each type of tag.

It should be noted, that under certain circumstances, while using the tags described herein, a portion of the tag labeled analytes may cleave at the first bond and/or a portion of the second bond may not cleave when subjected to a dissociative energy level from a mass spectrometer. In this scenario, quantitative or semi-quantitative information can be obtained so long as the yield of the charged mass-labeled analyte is about the same for each type of tag in the set.

Fragmentation techniques such as collisionally activated dissociation (CAD) may be used to fragment the tag labeled analytes. CAD may involve the acceleration of an ion beam (via the application of suitable voltages to electrodes adjacent to the ion path) into a collision region filled with neutral collision gas atoms or molecules (often helium, nitrogen or argon). Alternatively, CAD may be effected within an ion trap by applying a resonant excitation voltage to electrodes of an ion trap, causing the analyte ions to become kinetically excited and consequently undergo energetic collisions with neutral gas atoms or molecules present in the ion trap. As a result of collisions between the analyte ions and the neutral gas, some of the kinetic energy is converted into internal energy, which results in breaking the second bond. In addition, electron-transfer dissociation (ETD) may be used as a fragmentation technique where fragmentation of cations (e.g. peptides or proteins) is induced by transferring electrons to them. ETD is described in more detail in U.S. Pat. No. 7,534,622, which is hereby fully incorporated by reference herein. While the foregoing describes a few dissociation techniques, it should be understood that these descriptions are provided by way of example only, and does not limit the embodiments to any particular technique.

In an embodiment, a set of isobaric tags can include two or more types of tags. Each type of tag has about the same aggregate mass. However, the mass of the mass-labeling group for each type of tag is different.

In a first embodiment of a set of isobaric tags, it can include four types of tags. The four types of tags include a first, a second, a third, and a fourth mass-labeling group, respectively. The first mass-labeling group has a primary mass value (n). The second mass-labeling group has a second mass (n+m1) that is greater than the primary mass (n) by a first predetermined mass interval (m1). The third mass-labeling group has a third mass (n+m2) that is greater than the primary mass (n) by a second predetermined mass interval (m2). The fourth mass-labeling group has a fourth mass (n+m3) that is greater than the primary mass (n) by a third predetermined mass interval (m3). The first, second, and third predetermined mass intervals (m1, m2, and m3) may be about four, five, and six, respectively. In an embodiment, the first, second, and third predetermined mass intervals are each greater than or equal to four to ensure that natural isotopic variations of the analyte molecule do not interfere with the measurement of tag labeled analyte. Although an embodiment using four types of tags has been described, a set of isobaric tags can range from as few as two types and can also be greater than four types.

The mass of the second, third, and fourth mass-labeling group can be increased with respect to the first mass-labeling group by incorporating isotopically heavier atoms such as ¹³C, ¹⁴C, ¹⁵N, ¹⁷O, and ¹⁸O. Although the foregoing provides specific isotopic elements as examples suitable for use with the tags described herein, other types of isotopic elements may be used so long as they are stable for the duration of the analysis and allow for the mass of each type of tag in the set to be about the same. In an embodiment, the mass of the mass-labeling groups is not varied by changing the structure.

It should be noted that the mass of the first, second, third, and fourth mass-normalizing groups may need to be adjusted by incorporating isotopically heavier atoms so that each type of tag in the set have the same aggregate mass. A purpose of the mass-normalizing groups is to ensure that the total mass for each of the tag types are the same even though the mass of the mass-labeling group is unique for each of the types within the set. In an embodiment, the mass of the mass-normalizing groups is not varied by changing the structure.

In an embodiment, the reactive group may be a thiol, an acyl halide, an epoxide, a N-hydroxy succinimide, an isothiocyanate, an alcohol, a hydrazide, an aminooxy, or a combination thereof. More particularly, epoxide, N-hydroxy succinimide, and isothiocyanate are examples of aminoreactive groups. The analyte can include functional groups that can form a covalent linkage with at least one of the reactive groups described above. Such functional groups may be a thiol, an amine, an alcohol, an aldehyde, a carboxylic acid, or a combination thereof. The first bond that forms from the combination of the reactive group and the functional group may be a disulfide bond, a carbon-nitrogen bond, a carbon-sulfur bond, an amide bond, a thiourea based bond, an ester, a hydrazone bond, or a combination thereof.

In an embodiment, the mass-labeling group may include one or more amino acids joined together as a peptide. In addition, the mass-normalizing group may also include one or more amino acids joined together as a peptide. The mass-labeling group and the mass-normalizing group can be attached through second bond 104, which is an amide bond. In an embodiment, the second bond may be an amide bond between an aspartic acid and a proline. More particularly, the proline is part of the mass-labeling group and the aspartic acid is part of mass-normalizing group. When the second bond is cleaved, the proline may leave as a N-terminal charged ion and the aspartic acid leaves as a C-terminal neutral.

As an example, the mass-labeling group may have a sequence of Pro-Ala-Gly-[reactive group] and the mass-normalizing group may have a sequence of Gly-Ala-Val-Asp. Each tag includes a mass-labeling group and a mass-normalizing group that has the sequence of Gly-Ala-Val-Asp-Pro-Ala-Gly-[reactive group]. This sequence may have a light Ala and a heavy D₄-Ala, a light Gly and a heavy D₅-Gly, a light Val or a heavy ¹³C₅, ¹⁵N-Val, and a light Pro or a heavy ¹³C₅, ¹⁵N-Pro. The term “light” refers to an amino acid that has naturally occurring isotopes and does not have an enrichment with a heavier isotopic element. Tag 1 may include a peptide sequence of *Gly-*Ala-*Val-Asp-Pro-Ala-Gly-[reactive group]. Tag 2 may include a peptide sequence of *Gly-Ala-*Val-Asp-Pro-*Ala-Gly-[reactive group]. Tag 3 may include a peptide sequence of Gly-Ala-*Val-Asp-Pro-*Ala-*Gly-[reactive group]. Tag 4 may include a peptide sequence of Gly-Ala-Val-Asp-*Pro-*Ala-*Gly-[reactive group]. The asterisks identify the heavy isotope labeled positions. It should be noted that all tags have an identical mass, and cleavage occurs preferentially between the Asp and Pro positions. Upon CAD fragmentation, the four types of tags will have the following described arrangement. Tag 1 will have a 243 Da mass-labeling group attached to the analyte and liberate a 375 Da mass-normalizing group. Tag 2 will have a 247 Da mass-labeling group attached to the analyte and liberate a 371 Da mass-normalizing group. Tag 3 will have a 252 Da mass-labeling group attached to the analyte and liberate a 366 Da mass-normalizing group. Tag 4 will have a 258 Da mass-labeling group attached to the analyte and liberate a 360 Da mass-normalizing group.

The following will describe a method for using isobaric tags in analyzing an analyte such as a peptide. As used herein, the term “peptide” denotes any molecule comprising multiple amino acids linked by peptide bonds, and is intended to include intact proteins as well as protein fragments produced by proteolytic digestion of proteins. The tags will be used with MSⁿ analysis (n≧2) where each peptide that is labeled will retain a mass-labeling group. Examples of sample types that can be analyzed using the embodiments described herein include any variety of peptide-containing substances, such as cell lysates and biological fluids (e.g., blood, serum, or cerebrospinal fluid (CSF)). Once the samples are collected, they may each be digested with a proteolytic enzyme such as Lys-C or trypsin to produce peptides, some of which may serve as surrogates for the protein from which they are derived.

As an example, four different samples can be analyzed at the same time. The first, second, third, and fourth samples have a first, second, third, and fourth concentration of the analytes, respectively. The analyte can be a particular peptide resulting from the protein digest. In a first tube, a first sample can be incubated with a first type of tag to form a first tag labeled analyte. The incubation step is a labeling process that includes a time period where a reactive group of the tag can react with an analyte to form a tag labeled analyte. The first tag labeled analyte includes a first mass-labeling group coupled to the analyte via a first bond and a first mass-normalizing group coupled to the first mass-labeling group via a second bond.

In a second tube, a second sample can be incubated with a second type of tag to form a second tag labeled analyte. The second tag labeled analyte includes a second mass-labeling group coupled to the analyte via a first bond and a second mass-normalizing group coupled to the second mass-labeling group via a second bond.

In a third tube, a third sample can be incubated with a third type of tag to form a third tag labeled analyte. The third tag labeled analyte includes a third mass-labeling group coupled to the analyte via a first bond and a third mass-normalizing group coupled to the third mass-labeling group via a second bond.

In a fourth tube, a fourth sample can be incubated with a fourth type of tag to form a fourth tag labeled analyte. The fourth tag labeled analyte includes a fourth mass-labeling group coupled to the analyte via a first bond and a fourth mass-normalizing group coupled to the fourth mass-labeling group via a second bond.

The contents of the first, second, third, and fourth tubes can be combined together to form a sample mixture. Next, the sample mixture can be fractionated or cleaned up such as, for example, by using strong cation exchange chromatography column (i.e., SCX). To separate the various peptides in the sample mixture, liquid chromatography techniques can be used such as, for example, high pressure liquid chromatography (HPLC) or capillary chromatography. The chromatography effluent can then be injected into a mass spectrometer. Assuming that the first, second, third, and fourth tag labeled analytes have the same chemical structure, then all of the tag labeled analytes should elute at the same time. In most situations, changing the isotopes of carbon and nitrogen atoms of a molecule does not affect the chromatographic elution times.

The effluent can be ionized with an ionization device in the mass spectrometer and a particular m/z range of ions can be isolated, for example by applying a suitable resonant isolation waveform to an ion trap, or by selective transmission through a quadrupole mass filter. The first, second, third, and fourth tag labeled analytes can be co-isolatde because they all have the same mass. Other ions that have a different mass-to-charge ratio than the tag labeled analytes will be excluded from the ion trap. Next, all of the co-isolated tag labeled analytes can be subjected to a dissociative energy level with a mass spectrometer using a technique such as collisionally activated dissociation.

The second bond for all of the tag labeled analytes can be cleaved to form a neutral mass-normalizing group and a charged mass-labeled analyte. Thus, after the cleaving step, the first, second, third, and fourth tag labeled analytes form a, respective, first, second, third, and fourth charged mass-labeled analytes. In addition to forming charged mass-labeled analytes after the cleaving step, the first, second, third, and fourth mass-normalizing groups form a separated neutral species.

All of the charged mass-labeled analytes, that were formed after cleaving off of the mass-normalizing groups, can be measured in a mass analyzer of a mass spectrometer. The measured mass-to-charge ratios for each of the charged mass-labeled analytes are different because each type of mass-labeling group has a unique mass. This allows each of the samples to be quantified based on the corresponding peak magnitude of the mass spectrum. The first, second, third, and fourth concentration can be calculated based on the abundance value of the respective mass-to-charge ratios.

In another embodiment, a method for using isobaric tags may be performed without using a chromatographic separation. Under certain circumstances, the sample will not contain non-analyte peptides having m/z values coincident with the analyte peptide. In such a case, the sample mixture may be directly injected into a mass spectrometer without using a chromatographic separation beforehand.

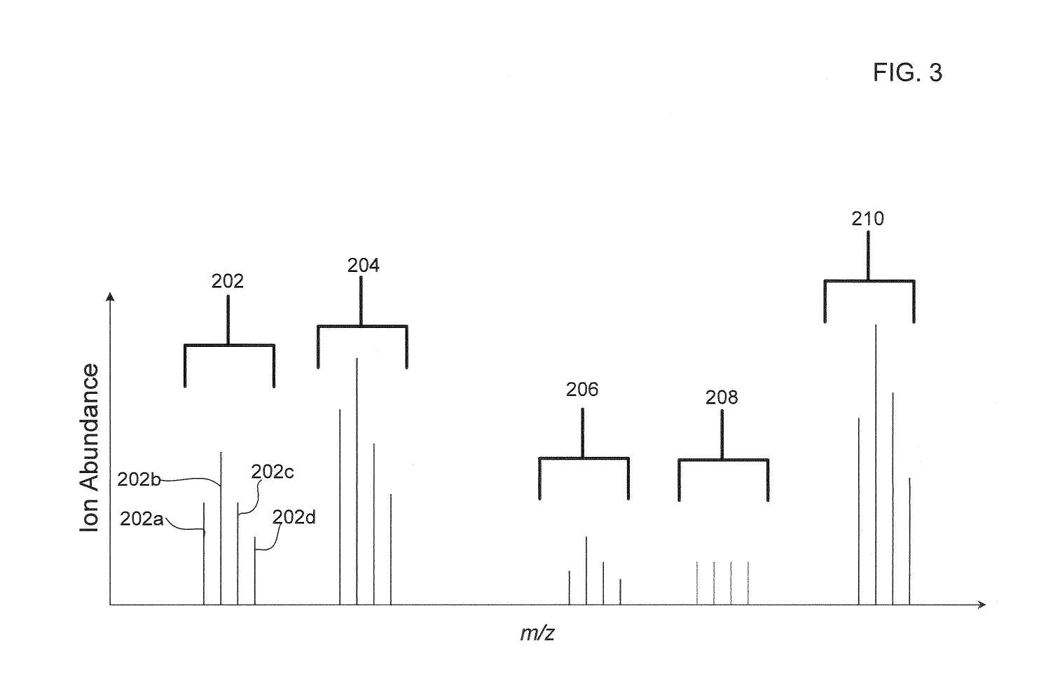

FIG. 3 illustrates a mass spectrum of a sample mixture using a set of isobaric tags where there are four types of tags. The first, second, third, and fourth type of tags corresponds to a, respective, first, second, third, and fourth mass-labeling groups. The first, second, and third predetermined mass intervals of the mass-labeling groups correspond to one, two, and three mass units.

The mass spectrum of FIG. 3 can be the result of a MS² analysis where a parent ion with a particular mass range is isolated and then fragmented. For each identified fragment cluster, the ion abundance pattern can also be analyzed. Fragment clusters from the parent may have a plurality of mass spectral peaks with ion abundances that are not substantially the same in magnitude.

Referring back to FIG. 3, the mass spectrum includes fragment clusters 202, 204, 206, 208, and 210. Fragment clusters represent a group of mass spectral peaks ascribed to a particular fragment of the analyte. The peaks in the clusters can be correlated to each type of tag used in the analysis based on the predetermined mass intervals.

A process check can be performed to determine the proportionality of each peak in the cluster with respect to a reference peak. For example, a primary (lightest) peak (e.g., 202a) can be used as a reference to calculate the ion abundance proportions for the other (heavier) peaks (e.g., 202b, 202c, and 202d). The fragment clusters 202, 204, 206, and 210 have the same proportion pattern of ion abundance values, and thus, share the same parent. The fragment cluster 208 has a different proportion pattern of ion abundances than the other fragment cluster, and thus, likely came from an interfering co-isolated ion. In many instances, the targeted peptide analyte will have a variation in abundance values within a cluster and that the majority of non-targeted (co-isolated) peptides will likelier have a uniform abundance values within a cluster. For this reason, non-targeted peptides tend to have a proportion pattern where all of the peaks within a cluster have approximately the same magnitude.

It should be noted that fragment identification can be primarily performed through a correlation with a MS/MS spectral database. In our case, each fragment is presented as a cluster of several ions. Because the distance between each ion in the cluster is different, it is easy to determine which ion corresponds to which sample (labeling channel) and also which ion series to use for data base search. A software utility can be used for pre-processing of multiplexed MS/MS spectra to result in convoluted ion series which are further searched against a database.

In an embodiment, one or more of the fragment clusters 202, 204, 206, and 210 may be used to calculate the analyte peptide concentration. An advantage of this method is that it provides a much higher specificity for quantitation since the mass-labeling group remains attached to the peptide during MS² analysis. It should be noted that this embodiment does not have interferences from other tag labeled non-analytes having a m/z value one or two units from the m/z value of the tag labeled analyte. In contrast to prior art methods where the reporter groups are cleaved during CAD, there is no mass-labeling group signal anonymity in this method, i.e. each structural fragment carries a tag and thus can be simultaneously identified and quantified.

A method for identifying a fragment cluster having tag labeled peptides can be based on the predetermined mass intervals of the mass-labeling groups. The peak spacing pattern should have four peaks because there are four types of isobaric tags. The four peaks should form a quartet pattern with an interval of one m/z unit between peaks because the predetermined mass intervals are one, two, and three.

In a second embodiment of a set of isobaric tags, it can have four types where the first, second, and third predetermined mass intervals are four, nine, and fifteen, respectively. The second embodiment is similar to the first embodiment, described above, except that the second and third predetermined mass intervals are greater in magnitude for the second embodiment. If the first type of mass-labeling group has a primary mass n, then the second, third, and fourth type have a second, third, and fourth mass of n+4, n+9, and n+15, respectively.

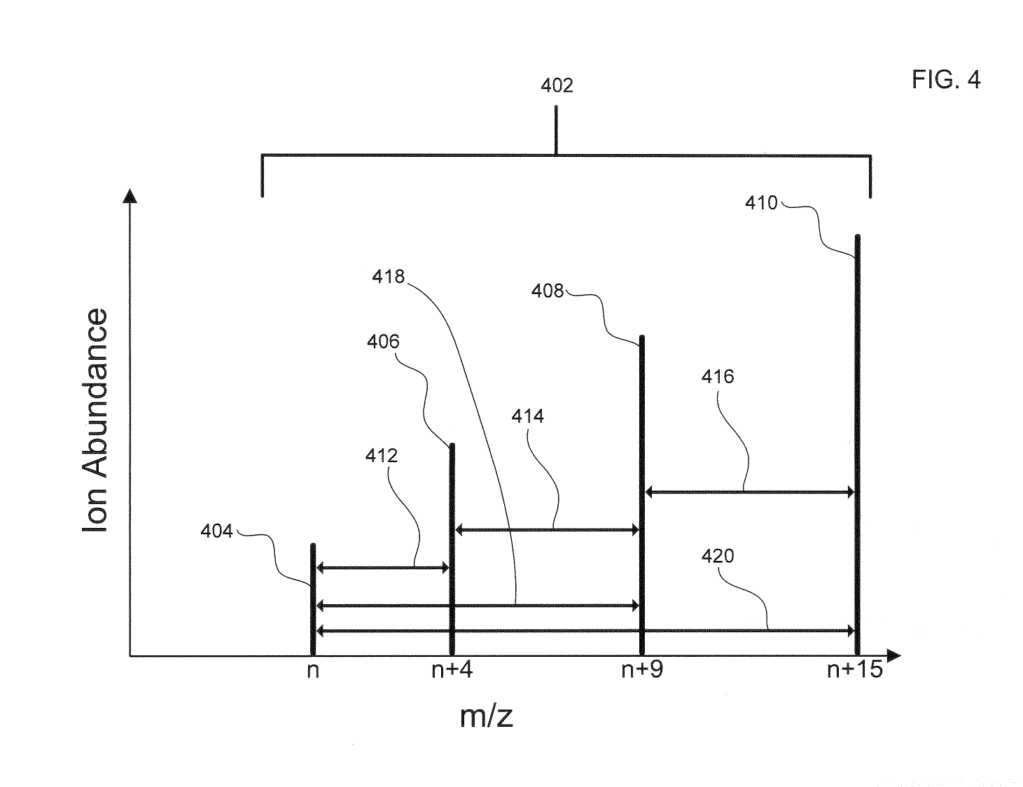

FIG. 4 illustrates a simplified and expanded mass spectrum of an analyte peptide labeled with isobaric tags of the second embodiment. A fragment cluster 402 includes the mass spectral peaks 404, 406, 408, and 410 that correspond to the first, second, third, and fourth charged mass-labeled analytes. In addition to the predetermined mass intervals (i.e., mass difference of a peak with respect to a primary mass), an intracluster mass interval can be defined (i.e., mass difference of a peak with respect to an immediately adjacent lighter peak). The first, second, and third predetermined mass intervals are denoted in FIG. 4 as double arrows 412, 418, and 420, respectively. A first intracluster mass interval 412 is a mass difference between a second and first type of tag (i.e., 4−0=4). A second intracluster mass interval 414 is a mass difference between a third and second type of tag (i.e., 9−4=5). A third intracluster mass interval 416 is a mass difference between a fourth and third type of tag (i.e., 15−9=6). Note that the intracluster mass intervals for the second embodiment increases from the first type to the fourth type (4, 5, and 6) as opposed to being a constant value for the first embodiment (1, 1, and 1).

The following will describe a method of analyzing four different protein samples using isobaric tags of the second embodiment. The four samples can each be digested with a proteolytic enzyme. Next, the digested samples can each be reacted with one of the tag types of the second embodiment so that each protein sample is reacted with only one type of tag and that a particular type of tag is not used twice. The four digested and tagged peptide samples can be combined so that a multiplexed MS² analysis can be performed. A method can be performed on the mass spectrum to identify fragment clusters from a parent ion of interest. Ideally, each fragment cluster should have a quartet pattern with a predetermined mass interval of four, nine, and fifteen. In addition, the quartet pattern should have an intracluster mass interval spacing of four, five, and six.

Under certain circumstances, one or more peaks can be missing from a mass spectrum that corresponds to a type of tag labeled analyte. In an experimental study, it is possible that one or more samples may have a very low concentration of an analyte peptide, which can be caused by, for example, a down regulation process of a cell. Even though one or more of the mass spectral peaks may be missing, the following method will show how to correlate the remaining peaks to the correct sample so long as there are at least two peaks in a cluster.

The second embodiment of the set of isobaric tags will be used as an example with the method of correlating mass spectral peaks to particular samples where there are missing peaks. For the second embodiment, a cluster in a mass spectrum should ideally be in the form of a quartet of peaks that corresponds to the first, second, third, and fourth charged mass-labeled analytes. The predetermined intracluster mass intervals can be calculated based on the predetermined mass intervals. For the second embodiment, the first, second, and third intracluster mass intervals may be about four, five, and six. In an embodiment, the method of correlating mass spectral peaks to particular samples when there are missing peaks can be based on at least one predetermined intracluster mass interval value or a sum of two or more of the predetermined intracluster mass interval values.

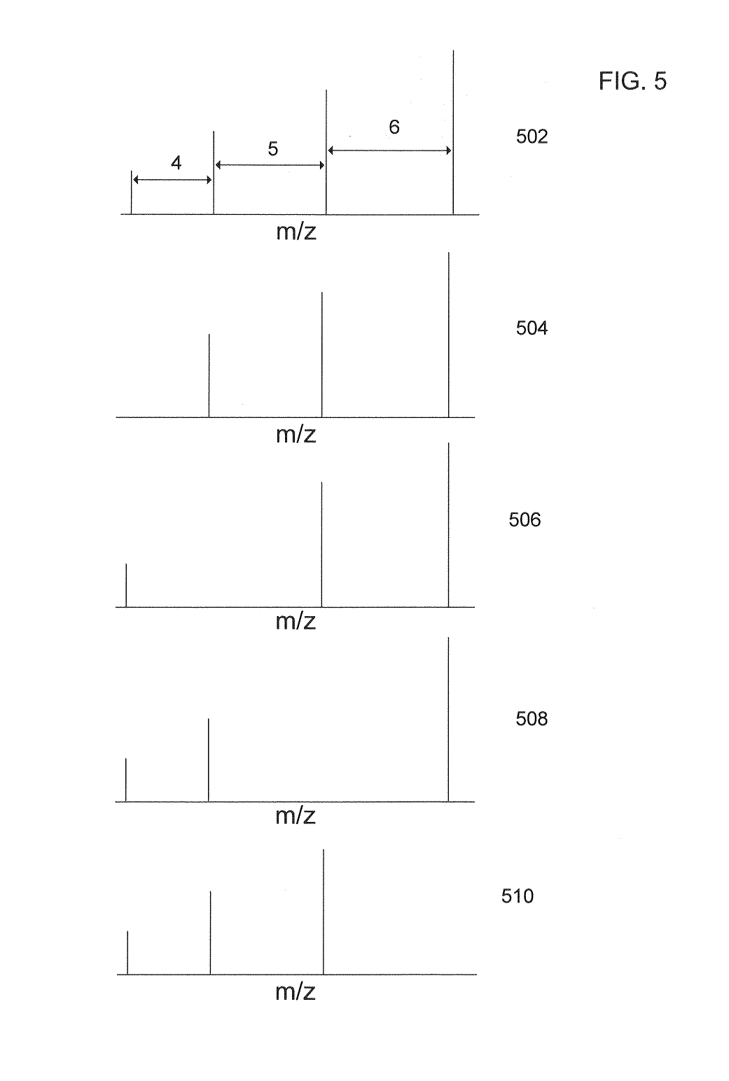

For the situation where there is one missing peak from a cluster, there will be only 3 peaks. The following will show the logic needed to correlate mass spectral peaks of a fragment cluster based on predetermined intracluster mass interval value(s) when one peak is missing from the quartet. The cluster can still be identified based on the three intracluster mass interval values (4, 5, and 6, see 502 of FIG. 5). Note that the y-axis of the spectra in FIG. 5 corresponds to the ion abundance intensity. In one scenario, the first (lightest) peak can be missing which would cause the three remaining peaks to have the second and third intracluster mass intervals (see 504 of FIG. 5). In another scenario, the fourth (heaviest) peak can be missing which would cause the three remaining peaks to have the first and second intracluster mass intervals (see 510 of FIG. 5). Accordingly, if the second peak is missing, then the three peaks will have intracluster distances that are the third intracluster mass interval, and a sum of the first and second intracluster mass intervals (see 506 of FIG. 5). If the third peak is missing, then the three peaks will have an intracluster distances that are the first intracluster mass interval, and a sum of the second and third intracluster mass intervals (see 508 of FIG. 5).

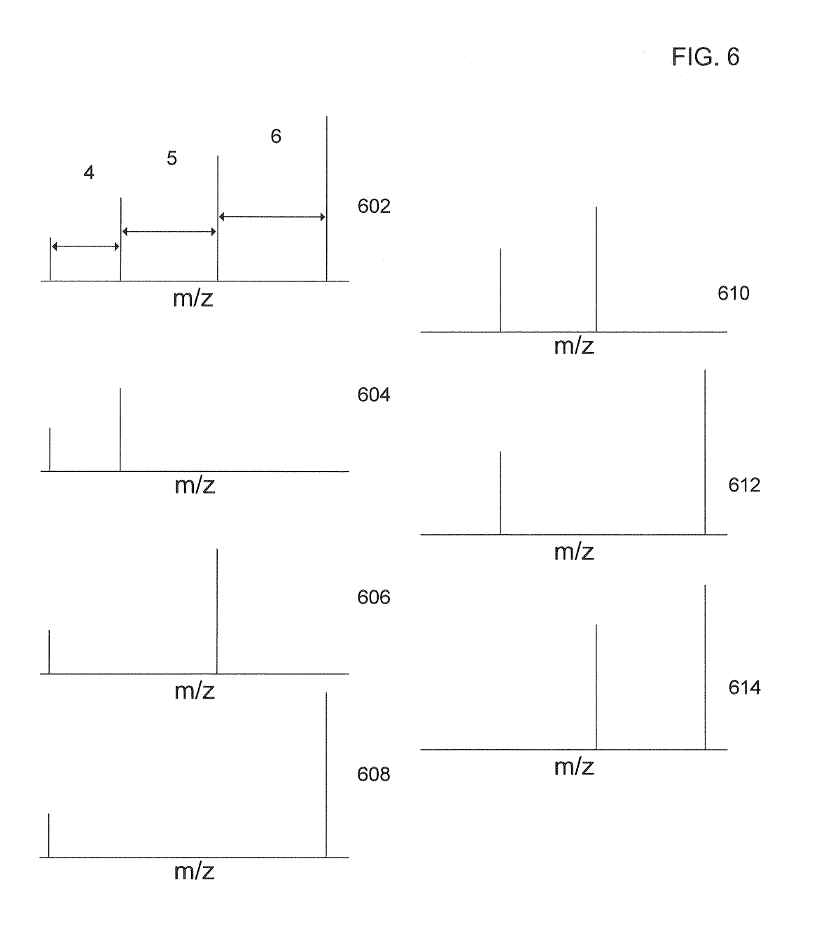

For the situation where there are two missing peaks from a cluster, there will be only 2 peaks. The following will show the logic needed to correlate mass spectral peaks of a fragment cluster based on predetermined intracluster mass interval value(s) when two peaks are missing from the quartet. The cluster can still be identified based on the three intracluster mass interval values (4, 5, and 6, see 602 of FIG. 6). Note that the y-axis of the spectra in FIG. 6 corresponds to the ion abundance intensity. In one scenario, the two lightest peaks (first and second peaks) can be missing which would cause the two remaining peaks to have the third intracluster mass interval (see 614 of FIG. 6). In another scenario, the two heaviest peaks (third and fourth peaks) can be missing which would cause the two remaining peaks to have the first intracluster mass interval (see 604 of FIG. 6). In yet another scenario, the lightest and heaviest peaks (first and fourth peaks) can be missing which would cause the two remaining peaks to have the second intracluster mass interval (see 610 of FIG. 6). If the second and fourth tags are missing, then the two remaining peaks would have an intracluster distance that is a sum of the first and second intracluster distances (see 606 of FIG. 6). If the first and third tags are missing, then the two remaining peaks would have an intracluster distance that is a sum of the second and third intracluster distances (see 612 of FIG. 6). If the second and third tags are missing, then the two remaining peaks would have an intracluster distance that is a sum of the first, second, and third intracluster distances (see 608 of FIG. 6). While the foregoing paragraphs describe a missing peak algorithm where there should be four mass spectral peaks, it should be understood that this description is provided by way of example only, and does not limit the invention to a missing peak algorithm for only four peaks and can be applied to fragment clusters having as low as three peaks and also to fragment clusters having five or more peaks.

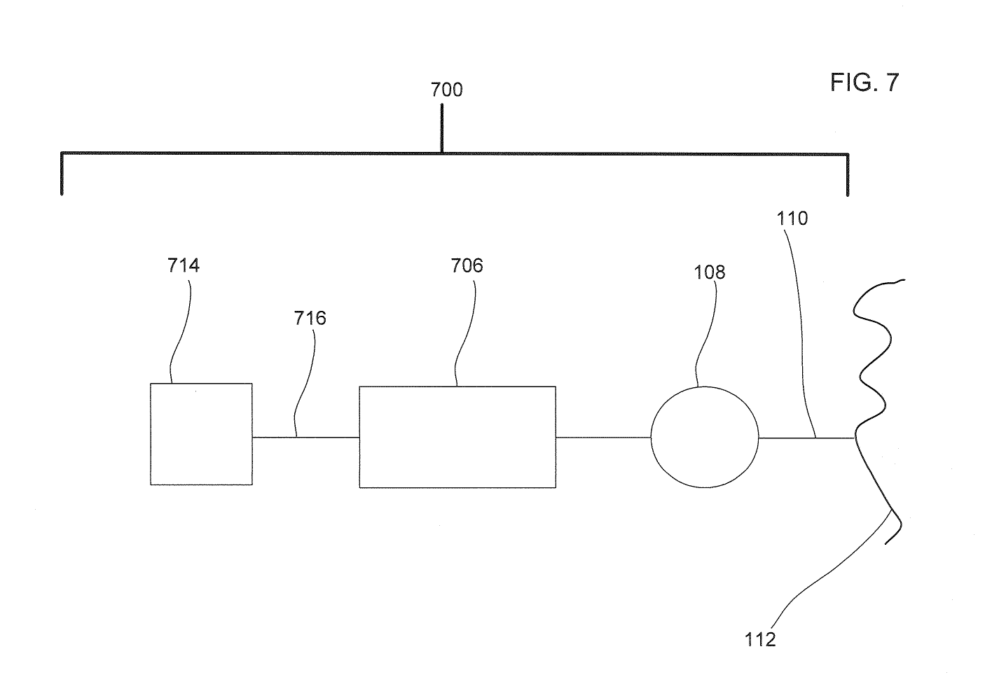

The following will describe an alternative embodiment of an isobaric tag 700 coupled to an analyte 112, as illustrated in FIG. 7. Isobaric tag 700 includes a mass-labeling group 706 and a signal group 714. The first mass-labeling group 706 includes a reactive group 108 configured to form a first bond 110 to a functional group of analyte 112 in a sample. The signal group 714 is attached to the first mass-labeling group 706 via a second bond 716.

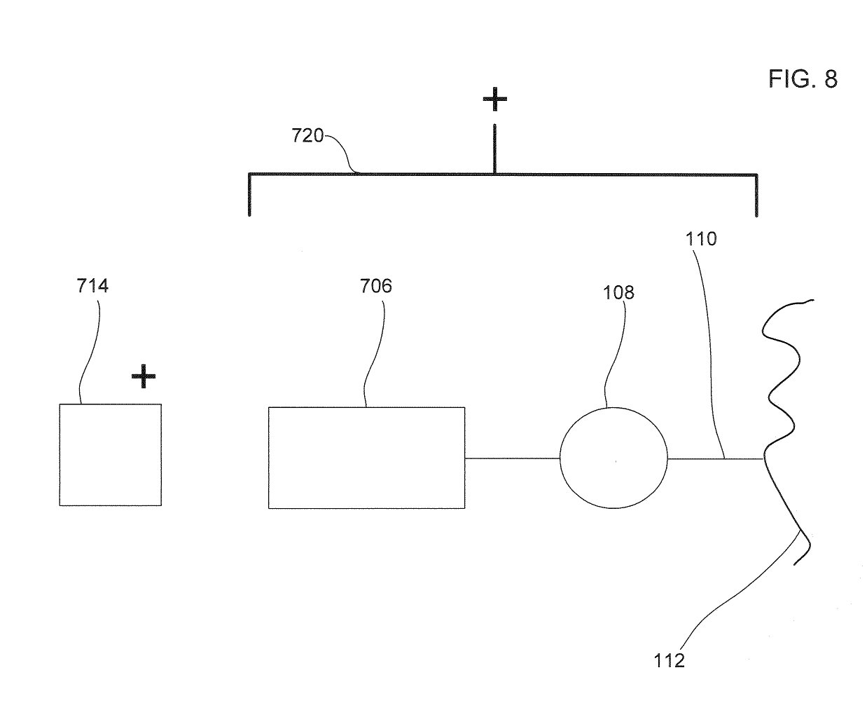

First bond 110 is configured to be stable and not cleave when subjected to a dissociative energy level from a mass spectrometer. When subjected to the same dissociative energy level, second bond 716 is configured to cleave so that the signal group 714 forms a separated charged molecule, as illustrated in FIG. 8. In turn, a remainder portion of the tag forms a charged mass-labeled analyte 720, as illustrated in FIG. 8.

In this alternative embodiment, a set of isobaric tags can include four types of tags that all have the same aggregate mass. However, the mass of each type of mass-labeling group 706 is different. At the same time, the mass of each type of signal group 714 is different too. In addition, the mass of the mass-labeling group 706 and signal group 714 must be balanced so that each type of tag has the same aggregate mass.

A set of isobaric tags 700 can be incubated with sample containing analyte. The tag labeled analytes can then be isolated (e.g., in an ion trap) based on a m/z range. Next, the trapped ions can be subjected to a dissociative energy level sufficient to cleave second bond 716. This results in the formation of a charged signal group and a charged mass-labeled analyte, which can both be measured with mass spectrometry. When subjected to the same dissociative energy level, the internal bonds of the mass-labeling group and the signal group are configured to be fragmentation resistant from the mass spectrometer. It should be noted that the m/z values for the charged signal group will be lower than the m/z values for the charged mass-labeled analyte.

Under certain circumstances, the tag labeled analyte of the alternative embodiment can cleave second bond 716 in a different manner. In a first scenario, a first proportion of the tag labeled analyte can form a neutral signal group 714 and a charged mass-labeled analyte 720. In a second scenario, a second proportion of the tag labeled analyte can form a charged signal group 714 and a neutral mass-labeled analyte 720. A combination of the first and second scenario can occur when the tag labeled analyte is subjected to dissociate energy levels from a mass spectrometer. It should be noted that a quantitative or semi-quantitative analysis can still be obtained with the proviso that the first proportion and/or the second proportion is approximately the same for each type of tag in the set.

In contrast to the first and second embodiment using isobaric tag 100, the alternative embodiment using isobaric tag 700 has two sources of analytical signals that can each individually be used to determine the same analyte concentration. The first source is from the charged mass-labeled analytes that can provide a first set of analyte concentrations for each type of tag, which is similar to the first and second embodiments using isobaric tag 100. The second source is from the charged signal groups that can provide a second set of analyte concentrations for each type of tag.

In an embodiment, a hybrid method can be used to determine the analyte concentration by using both sources of analytical signals. For example, a concentration of a particular analyte can be calculated twice using both signal sources and then averaged to provide a more accurate measurement.

Alternatively, this hybrid method can be used to detect if there are interfering ions co-isolated in the ion trap during MS² analysis. If a particular analyte concentration determined from the first source differs from the corresponding analyte concentration determined from the second source by a predetermined threshold, then this can indicate an interfering ion was co-isolated in the ion trap. In an embodiment, the predetermined threshold may be set by a user.

Those skilled in the art will recognize the methods and techniques described above may be practiced in any mass spectrometer capable of MSⁿ analysis, whereby one or more stages of mass isolation and fragmentation are performed for acquisition of a product ion spectra. Examples of suitable mass spectrometers include a tandem mass spectrometer, triple quadrupole mass spectrometer, a hybrid quadrupole time-of-flight, a Fourier transform ion cyclotron resonance spectrometer, an Orbitrap mass spectrometer, an ion trap mass spectrometer, and a time-of-flight (TOF) mass spectrometer. Another example of a suitable mass spectrometer includes a single stage mass spectrometer with an all-ion fragmentation mode (AIF) such as electrospray ionization TOF and electrospray ionization Orbitrap.

While preferred embodiments of the present invention have been shown and described herein, it will be apparent to those skilled in the art that such embodiments are provided by way of example only. Numerous variations, changes, and substitutions will now occur to those skilled in the art without departing from the invention. While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A set of two or more types of isobaric tags, each tag in the set comprising:
(a) a mass-labeling group including a reactive group, the reactive group configured to form a first bond to a functional group of an analyte, the first bond is configured to be stable when subjected to a dissociative energy level from a mass spectrometer so that the first bond does not cleave;
(b) a mass-normalizing group attached to the mass-labeling group via a second bond, the second bond is configured to cleave when subjected to the dissociative energy level from the mass spectrometer; in which a mass of each type of tag in the set is about the same, in which a mass of a mass-labeling group for each type of tag in the set is different, and in which the tag is configured to form a charged mass-labeled analyte when the second bond is cleaved.

2. The set of two or more isobaric tags of claim 1, in which the reactive group is selected from the group consisting of a thiol, an epoxide, a N-hydroxy succinimide, an isothiocyanates, an alcohol, a hydrazide, an acyl halide, an aminooxy, and a combination thereof.

3. The set of two or more isobaric tags of claim 1, in which the first bond is selected from the group consisting of a disulfide bond, a carbon-nitrogen bond, an amide bond, a thiourea based bond, an ester, a hydrazone bond, a carbon-sulfur bond, and a combination thereof.

4. The set of two or more isobaric tags of claim 1, in which the charged mass-labeled analyte comprises an analyte attached to a mass-labeling group and the charged mass-labeled analyte does not comprise a mass-normalizing group.

5. The set of two or more isobaric tags of claim 1, in which the second bond comprises an amide bond between aspartic acid and proline.

6. The set of two or more isobaric tags of claim 1, in which the mass-normalizing group is configured to form a neutral molecule when the second bond is cleaved.

7. The set of two or more isobaric tags of claim 1, in which the analyte comprises a peptide.

8. The set of two or more isobaric tags of claim 1, in which a first mass of a first mass-labeling group and a second mass of a second mass-labeling group are different by about four mass units or more.

9. The set of two or more isobaric tags of claim 1, in which the mass-labeling group is configured to be fragmentation resistant when subjected to the dissociative energy level from the mass spectrometer.

10. A method of analyzing an analyte with isobaric tags, the method comprising:
(a) incubating a first type of tag with a first sample containing a first concentration of the analyte to form a first tag labeled analyte, the first tag labeled analyte comprising:
(1) a first mass-labeling group coupled to the analyte via a first bond;
(2) a first mass-normalizing group coupled to the first mass-labeling group via a second bond,
(b) incubating a second type of tag with a second sample containing a second concentration of the analyte to form a second tag labeled analyte; the second tag labeled analyte comprising:
(1) a second mass-labeling group coupled to the analyte via a first bond;
(2) a second mass-normalizing group coupled to the second mass-labeling group via a second bond,
(c) subjecting the first tag labeled analyte and the second tag labeled analyte to a dissociative energy level with a mass spectrometer;
(d) cleaving the first bond of the first tag labeled analyte to form a neutral first mass-normalizing group and a first charged mass-labeled analyte;
(e) cleaving the second bond of the second tag labeled analyte to form a neutral second mass-normalizing group and a second charged mass-labeled analyte;
(f) measuring a mass-to-charge ratio of the first charged mass-labeled analyte and the second charged mass-labeled analyte where the mass-to-charge ratio of the first charged mass-labeled analyte is different than the second charged mass-labeled analyte.

11. The method of claim 10 further comprising: after incubation steps (a) and (b), combining the first tag labeled analyte and the second tag labeled analyte together to form a sample mixture

12. The method of claim 10 further comprising: determining the first concentration and the second concentration based on of the abundance values of the respective mass-to-charge ratios of the first charged mass-labeled analyte and the second charged mass-labeled analyte.

13. The method of claim 10, in which a mass of the first tag labeled analyte and the second tag labeled analyte are about the same.

14. The method of claim 10 further comprising: before the subjecting step (c), co-isolating the first tag labeled analyte and the second tag labeled analyte from other components in the first and second samples using a liquid chromatograph.

15. The method of claim 10 further comprising: before the subjecting step (c), treating the sample mixture with an ionization device in the mass spectrometer.

16. The method of claim 15 further comprising: after the treating step, co-isolating the first tag labeled analyte and the second tag labeled analyte from other ions that have a different mass-to-charge ratio than the tag labeled analytes in an ion trap.

17. A method of analyzing an analyte with isobaric tags, the method comprising:
(a) incubating a first type of tag with a first sample;
(b) where the first sample contains the analyte, forming a first tag labeled analyte, the first tag labeled analyte comprising:
(1) a first mass-labeling group coupled to the analyte, the first mass-labeling group having a primary mass;
(2) a first mass-normalizing group coupled to the first mass-labeling group,
(c) incubating a second type of tag with a second sample;
(d) where the second sample contains the analyte, forming a second tag labeled analyte, the second tag labeled analyte comprising:
(1) a second mass-labeling group coupled to the analyte, the second mass-labeling group having a second mass that is greater than the primary mass by a first predetermined mass interval;
(2) a second mass-normalizing group coupled to the second mass-labeling group,
(e) incubating a third type of tag with a third sample;
(f) where the third sample contains the analyte, forming a third tag labeled analyte, the third tag labeled analyte comprising:
(1) a third mass-labeling group coupled to the analyte, the third mass-labeling group having a third mass that is greater than the primary mass by a second predetermined mass interval;
(2) a third mass-normalizing group coupled to the third mass-labeling group,
(g) combining the first sample, the second sample, and the third sample together to form a sample mixture;
(h) subjecting the sample mixture to a dissociative energy level with a mass spectrometers suitable for cleaving mass-normalizing groups from tag labeled analytes to form charged mass-labeled analytes;
(i) measuring mass-to-charge ratio values of charged mass-labeled analytes;
(j) identifying at least two mass-to-charge ratio values that correspond to two types of charged mass-labeled analytes so long as the at least two mass-to-charge ratio values have a mass spacing that corresponds to a predetermined intracluster mass interval value or to a sum of two predetermined intracluster mass interval values.

18. The method of claim 17, in which a first predetermined intracluster mass interval includes a mass difference between the second and the first type of tags, and a second predetermined intracluster mass interval includes a mass difference between the third and the second type of tags.

19. The method of claim 17, in which a mass of the first, second, and third tag labeled analyte is about the same.

20. The method of claim 17 further comprising: before the subjecting step (h), co-isolating tag labeled analytes from other components in the sample mixture using a liquid chromatograph.

21. The method of claim 17 further comprising: before the subjecting step (h), treating the sample mixture with an ionization device in the mass spectrometer.

22. The method of claim 21 further comprising: after the treating step, co-isolating tag labeled analytes from other ions that have a different mass-to-charge ratio than the tag labeled analytes in an ion trap.

23. The method of claim 17, in which mass-normalizing groups form a neutral molecule after being cleaved.

24. The method of claim 17, in which the analyte comprises a peptide.

25. The method of claim 17, in which the first predetermined mass interval is about 4 or more mass units.

26. The method of claim 17, in which the second predetermined mass interval is about 5 or more mass units.

27. A set of two or more types of isobaric tags, each tag in the set comprising:
(a) a mass-labeling group including a reactive group, the reactive group configured to form a first bond to a functional group of an analyte, the first bond is configured to be stable when subjected to a dissociative energy level from a mass spectrometer so that the first bond does not cleave;
(b) a signal group attached to the mass-labeling group via a second bond, the second bond is configured to cleave when subjected to the dissociative energy level from the mass spectrometer; in which a mass of each type of tag in the set is about the same, in which a mass of a mass-labeling group for each type of tag in the set is different and a mass of a signal group for each type of tag in the set is also different, and in which the tag is configured to form a charged mass-labeled analyte and a charged signal group when the second bond is cleaved.

28. The set of two or more isobaric tags of claim 27, in which a first mass of a first mass-labeling group and a second mass of a second mass-labeling group are different by about four mass units or more.

29. The set of two or more isobaric tags of claim 27, in which the mass-labeling group and the signal group are configured to be fragmentation resistant when subjected to the dissociative energy level from the mass spectrometer.
